(19) United States
(12) Patent Application Publication
(10) Pub. No.: US 2006/0190975 A1
(43) Pub. Date: Aug. 24, 2006

(54) Method and apparatus for providing video on-demand

(76) Inventor: Carlos Gonzalez, Fairfax, VA (US)

Correspondence Address: Carlos Gonzalez, 3924 Tedrich Blvd., Fairfax, VA, 22031, US

(21) Appl. No.: 11/064,490

(22) Filed: Feb. 24, 2005

(51) Int. Cl. H04N 7/173

(52) U.S. Cl. 725/88; 725/102; 725/87; 725/89

(57) ABSTRACT

The present invention is generally related to a method and a device for providing video on-demand. Our method consists of transferring a selected video over a broadcast signal to a user platform where it will be saved and played under user's control. The user will have the video available for a set time, and optionally able to buy the video and save it either to an external storage or make a copy of the video. The device will have an optional connection to a network. Our method allows a user to run different applications to manage the user's video collections.

### BACKGROUND AND SUMMARY OF THE INVENTION

At the present time, if you want to see a movie, you have 3 basic alternatives: 1) go to a movie theater, 2) go to your local video store and rent one, or 3) call your cable company and buy an on-demand movie. There are advantages and disadvantages for each of the choices. With the first two, you have to go out of your home to get what you want. The difference between the movie and the video rental is that the movie has the latest films. On the other hand, it is more expensive (more noticeable if more than one person is involved) and you have a greater variety of choices at your local video store. The disadvantage of the video store is that you have to go to the store twice to get and see a movie (once to pick it up, and a second time to return it). With most cable companies the renting of an on-demand program implies that you have to see the movie at the designated times that the cable is showing the movie, and you don't have any control over stopping, rewinding or pausing. Cable companies that give you the advantage of a VCR-like capability use cable lines to manage the program, limiting the selection of options that is given, this happens because the video is not located locally with the user. With any of the cable companies you don't have the option of buying the video. Previous work like U.S. Pat. Nos. 6,804,825, 6,392,664; and 6,829,250 are based on the usage of an interactive network to communicate with the user, and the location of the video to be displayed is not on the user platform but on another platform (e.g. head end, proxy, etc.). Other related work U.S. Pat. Nos. 6,807,538, 6,813,777 or 6,529,940 use a closed network. What we are proposing here is to transfer the selected video over a broadcast signal (e.g. satellite signal, cable signal analog or digital) to a user platform where it will be saved and played under the user's control. This approach provides the advantage of relinquishing to the user control of when to start, stop, replay and pause the video, with the extra advantage of doing the selection from the user's home (the user doesn't have to go out either to pick-up or return the video). Another advantage for the user is not having to deal with the media itself (like the DVD disk), since they are at the present time very easy to scratch (after many rentals) and produce bad signals. This is also an advantage for the video provider, since no media is involved with this approach. The main advantage for the video provider is that it can provide a large selection of videos since the transmission channels will only be used for short periods of time to download the video (which could be done on a compressed mode), rather than the long transmission of the video itself.

### BRIEF DESCRIPTION OF THE DRAWINGS

Other objects and advantages of the invention will become more apparent from the specification taken in conjunction with the accompanying drawings, in which:

FIG. 1. is a high level system diagram of the invention

FIG. 2. is a system diagram of the invention with the functional decomposition of the Video-On-Demand Command Module and its basic composition.

FIG. 3. is a system diagram of the invention with the functional decomposition of the Video-On-Demand Command Module and its basic composition plus a Video Duplicator.

FIG. 4. is a system diagram of the invention with the functional decomposition of the Video-On-Demand Command Module and its basic composition plus a Removable Storage.

FIG. 5. is a system diagram of the invention with the functional decomposition of the Video-On-Demand Command Module and its basic composition plus a Network Interface.

FIG. 6. is a system diagram of the invention with the functional decomposition of the Video-On-Demand Command Module and its basic composition plus a Video Duplicator, a Removable Storage, and a Network Interface.

FIG. 7. is a system diagram of the invention with the hardware components' decomposition of the Video-On-Demand Command Module and its basic composition.

FIG. 8. is a system diagram of the invention with the hardware components decomposition of the Video On Demand Command Module and its basic composition plus an attached External Storage.

FIG. 9. is a system diagram of the invention with the hardware components decomposition of the Video On Demand Command Module and its basic composition in which the Video Player now has a Video Recorder capability.

FIG. 10. is a system diagram of the invention with the hardware components decomposition of the Video On Demand Command Module and its basic composition in plus a Network Interface Unit.

FIG. 11. is a system diagram of the invention with the hardware components decomposition of the Video-On-Demand Command Module and its basic composition plus a Video Recorder capability, an attached External Storage, and a Network Interface Unit.

### DETAILED DESCRIPTION OF THE INVENTION

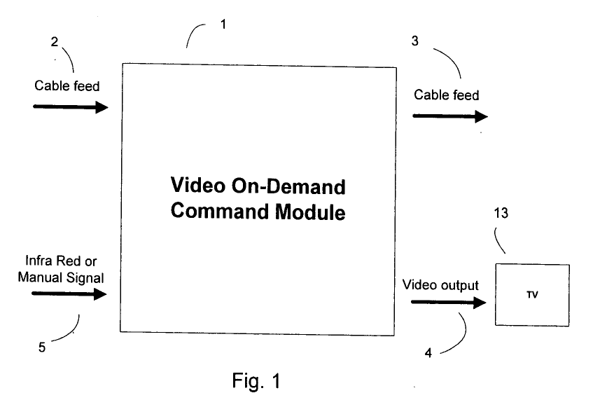

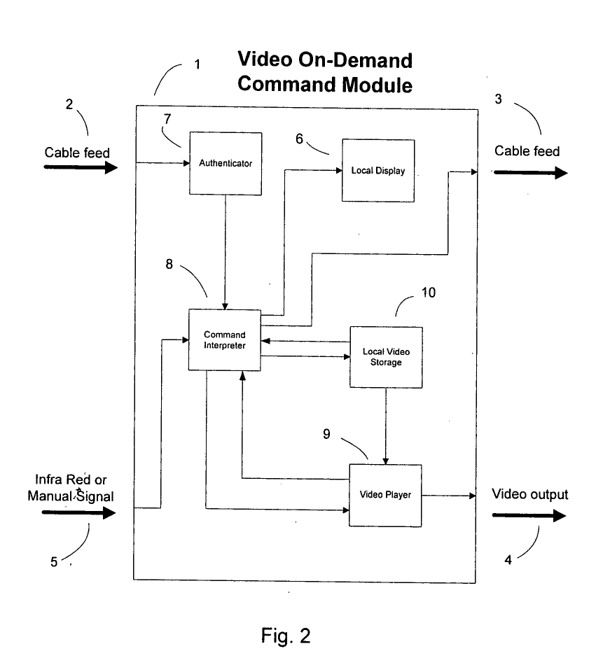

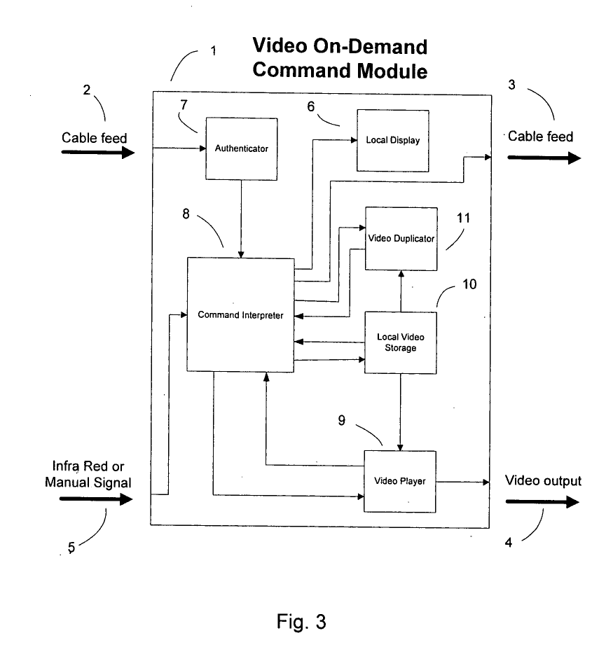

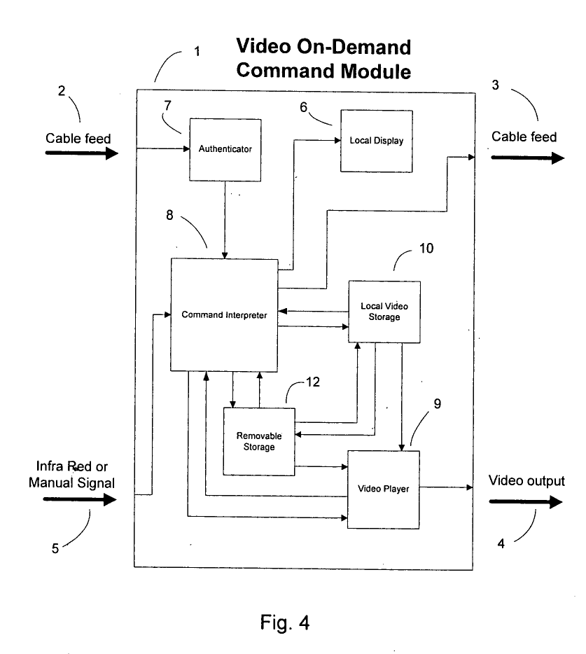

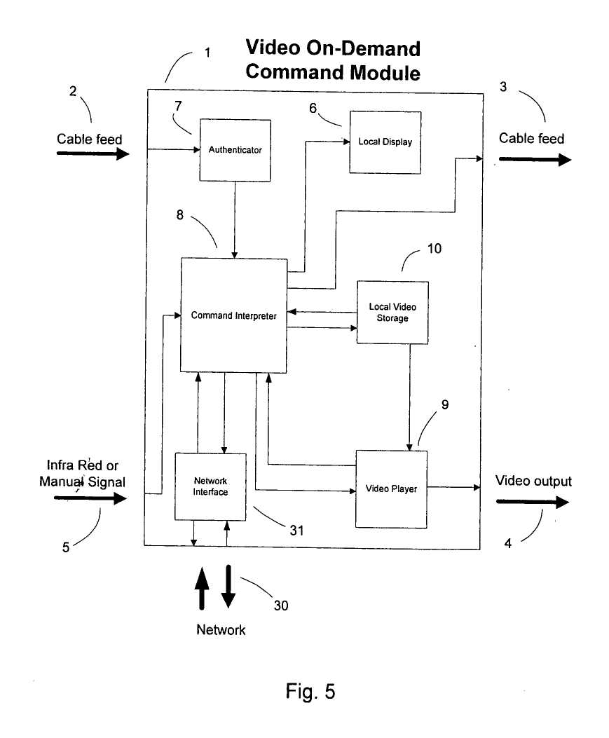

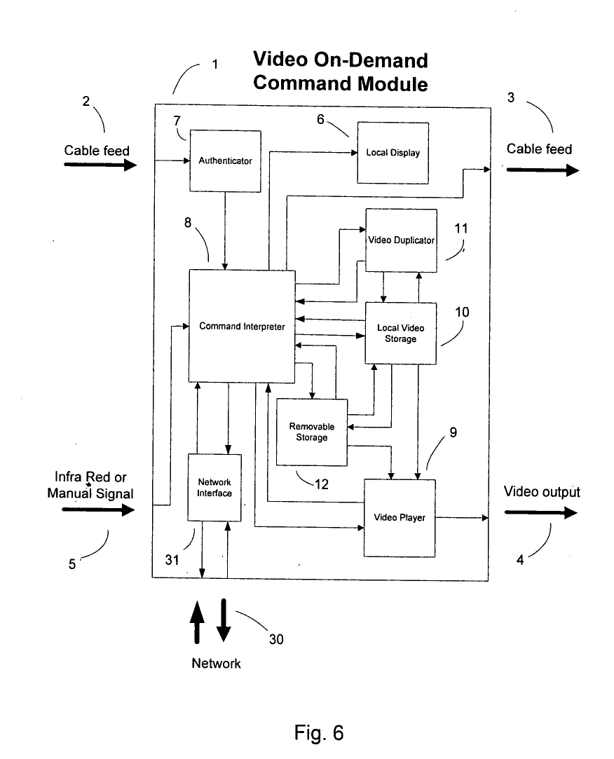

As shown in FIG. 1. our proposed invention is comprised of a device 1 (we will call this device the Video-On-Demand Command Module VODCM) that will receive input from the video signal provider (i.e. the cable company) and will manage that video input 2 before providing an output signal 3 and/or 4. Referring to FIG. 2. The management of the signal will consist first of recognizing (by an Authenticator 7) a video on-demand input 2, and performing the appropriate on-demand command (by a Command Interpreter 8). For example, one of the signals will be a command saying there is on-demand data following this command, and it will then save the complete signal into the local memory 10. Signals that are not video on-demand data or commands will be passed along untouched to the regular cable feed 3. Once the on-demand video data is saved, environmental information about the video is also stored 10 (this information may come included in the heading or the trail of the signal). The environmental information will contain for example, the date of the download, the expiration date, the name of the film, duration, ratings, etc. Once the complete download of the video is done, the user will be notified (a signal to both, the local display on the VODCM 6, and to the video output 4). When the video is loaded and ready in the VODCM, the user can select to play such a video by providing a local command signal 5 (either by a remote control or manually), the VODCM then transfers the video data from storage 10 to the Video Player 9 which will transmit the video signal 4 to the user as if it was playing from a regular DVD player or VCR. In other words, the user will be able to provide local command signals to select when to play, stop, pause, fast forward, and so on. The video will be available to the user for a certain period of time (for example 2 or 3 days as is customary for rental video stores). When the time expires, the VODCM will make this video unavailable to the user. In other words, the user doesn't have to do anything like returning the video. The VODCM has a large capacity local storage 10 able to hold several videos at the same time. A VODCM can have extra functionality than the one provided by the basic unit depicted in FIG. 2. FIG. 3. shows a basic unit with a Video Duplicating Module 11, FIG. 4. shows a basic unit with a Removable Storage Module 12, and FIG. 5 shows a basic unit with a Network Interface 31. FIG. 6 shows a VODCM with all modules. The VODCM has the capability of incorporating a removable non-volatile external storage 12 (e.g. hard disk, flash memory, etc.). This external storage will provide unlimited storage of video data. If part of the environment information that was received with the video data was that the user bought the video instead of just renting it, then, the VODCM will not erase the video, and allow the user to make a copy using the VDOCM capabilities of Duplicating Videos 11 or save it into the Removable Storage unit 12, or send the video to another network location 31 through the Network Interface 30.

The VODCM will have all the capabilities of a DVD player and a DVD burner. Therefore, the user can use the VODCM for video on-demand, as a DVD player, and as a DVD burner.

Besides having the capabilities of a DVD player and a DVD burner, the VODCM will have the capability of interacting with the user by the user generating local command signals and the VODCM responding to the user (through the Video output signal 4) on the TV screen attached to the VODCM (see FIG. 1 number 13). When the VODCM is powered on, the VODCM will present the user with a main menu that contains the status of the VODCM and a list of possible VODCM commands. The status will indicate which videos are currently in the local storage, their names, length, rating, expiration date (if any), and the total currently available space in the local storage. The main menu commands are:

Select a video

Play a video

Duplicate a video

Delete a video

Removable Storage

Applications

Activity Log

Security

Network

After a command is completed the VODCM will return to display the main menu for the user. A command may require more than one screen to complete the command.

The Removable Storage command will allow the user to manage the contents in the Removable Storage. An example of management commands are: display list of the current contents, select and delete a video, select and play a video, etc. This command will not be available when the VODCM has no external Removable Storage currently attached.

By means of the Applications command the user will be able for example, to load into the VODCM (done through the video data signal, or the removable storage, or the video player, or the network) different kinds of sets of commands for a variety of applications. For example, a user with a collection of videos with a food theme will require different classification (e.g. main dishes, desserts, breads, Mexican, soups, etc.), indexing, and search requirements than a user managing a collection of movies (with classifications like adventure, comedy, drama, current releases, etc.).

The Activity Log command will display the latest activities done with the VODCM, like the name and date/time a video was played, when it was deleted, when it was copied, etc. This log will be kept on a finite (e.g. 100 entries) storage media that will be managed as a queue (first in, first out).

The Security command will be used to set up restricted access to execute some of the commands. For example, a father may want to restrict the playing of R movies without his authorization, or may want to be the only one authorized to duplicate videos. The use of the Security command will be restricted by the use of a password. The VODCM will have an initial set-up password when the VODCM is delivered to the user.

The Network command will allow the user to communicate, set-up, and manage the connection to the network.

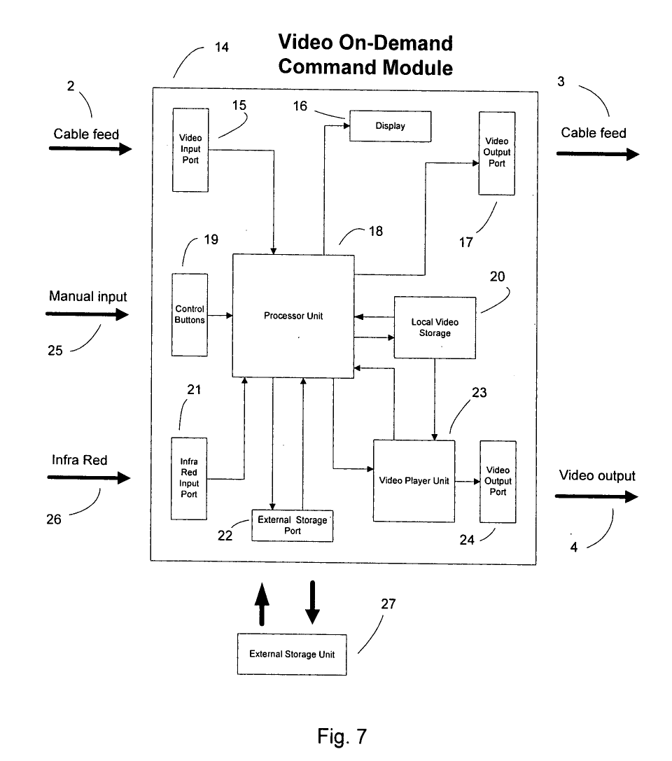

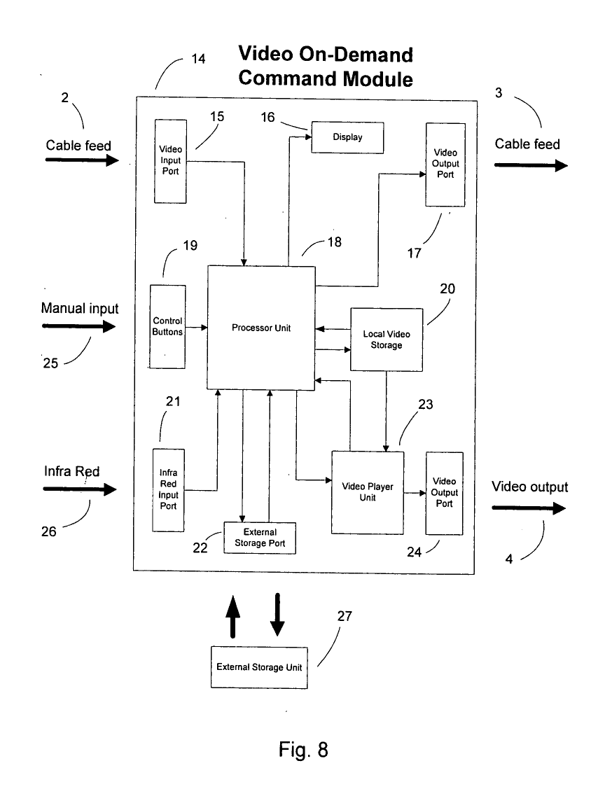

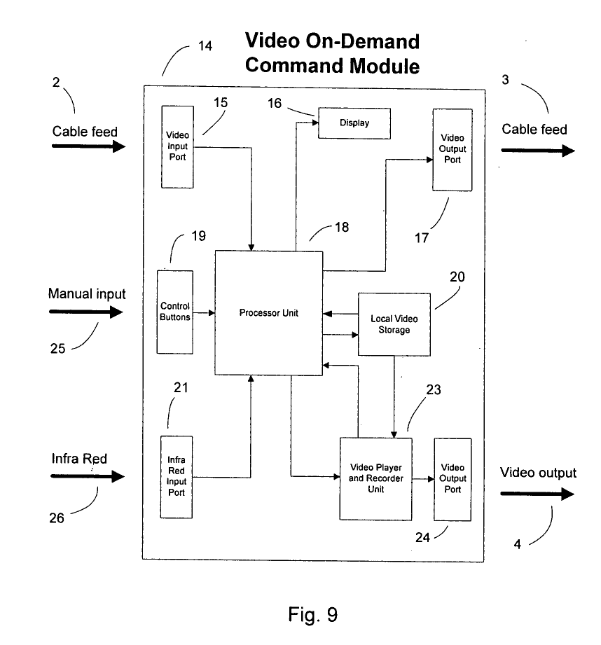

FIG. 7. shows the hardware components of the VODCM 14. The broadcast signal 2 will be received by a Video Input Port 15 (and convert if necessary, the signal to digital form) and pass it along to the main Processing Unit (PU) 18. This unit will receive and analyze the signal (if the signal was encrypted for security purposes, a decryption process is carried out by the PU). If the signal is not video on-demand, then the signal is passed to the cable feed 3, through a Video Output Port 17. If the signal was video on-demand, then the PU will send the signal to the Local Video Storage 20 to be saved. Once the complete video on-demand signal is received and stored, the PU will send a signal to the local display unit 16 to display the proper display message. Also a signal is sent to the video output through the Video Player 23 and the Video Output Port 24. When the user sends a signal by either depressing a button on the remote control (generating an Infra Red signal 26) or depressing the local buttons (generating a Manual Input 25), the PU analyzes the signal and executes the proper command. For example, if the command given was to play a selected video existent in the local storage 20, the PU will send commands to the Video Player 23 to start getting the data from the local storage 20, and transmitting it to the Video output 4 through the Video Output Port 24. If the VODCM has the capability of duplicating videos as shown in FIG. 8, then if the user command (through either signal 25 or 26) is a “duplicate video” command and such command is allowed for the selected video, the PU 18 communicates with the user (through either a signal to 16 or 4) to load the proper media. Once the media is loaded, the PU will be notified (through either signal 25 or 26 or the Video Player/Recorder Unit 28) and proceed to send the selected video from the Local video Storage 20 to the Video Player/recorder Unit 28 to start duplicating the video. FIG. 9 has a VODCM 14 with an attached External Storage Unit 27. Notice that the VODCM has an External Storage Port 22, but such port will not be active until an External Storage is attached to it. The user will be able to attach and remove the External Storage Unit 27 at will. Once attached to the VODCM, the transfer of data will be done through the External Storage Port 22. Since the External Storage Unit 27 is removable, the user can have many of these units.

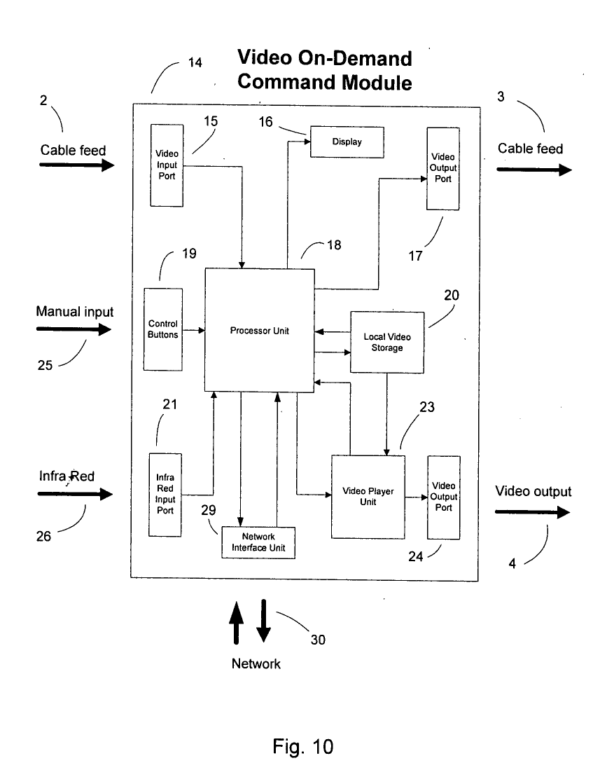

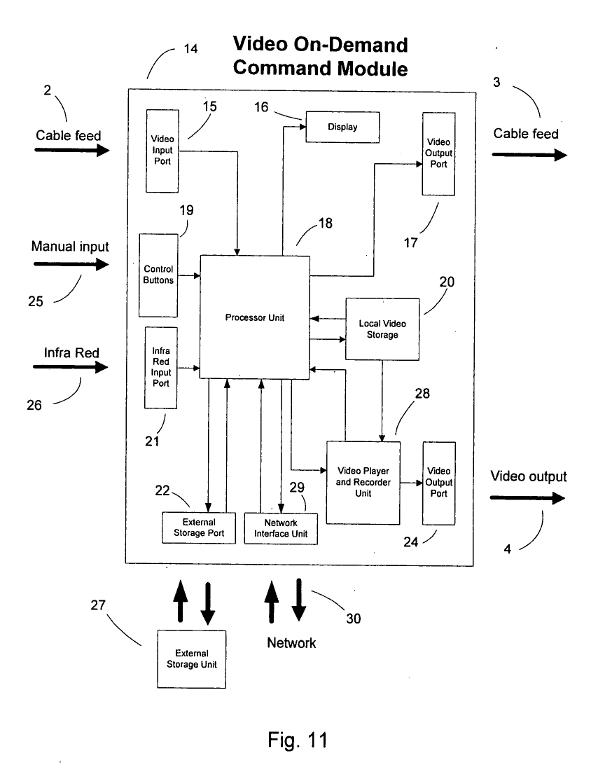

The VODCM is also capable of having a Network Interface Unit FIG. 10. number 29, and will be able to receive and send data from a Network 30. An example of the data that can be received/sent to the Network is an application to run in the VODCM PU 18, or video data to store in the local storage. FIG. 11. shows a VODCM with an the External Storage Port 22, a Video Player/Recorder Unit and a Network Interface Unit. The Processing Unit in this invention is conceived as being like a Personal Computer with its own RAM memory and local storage, having ports to easily connect external storage, a network interface card, and interfaces to communicate with a DVD-like player/recorder, and video input/output.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the present invention.

I claim:

1. A method of providing on-demand video comprising: receiving a broadcast video signal; on said signal receive on-demand video data and commands; storing the on-demand video data and commands in a local storage device; displaying on a local display a signal to indicate the end of said video storing; sending to the TV via the video output a signal displaying the current status of the local storage and a list of user commands; receiving a user action to play the on-demand video by actuating a PLAY button located on a remote control or on the local video player, or highlighting a PLAY command on the TV and depressing an ENTER button on the remote control; transferring the on-demand data stored on said storage to a video player; sending a signal to the video player to start playing the on-demand video; sending the output of the video player to the TV via the video output channel.

2. The method of claim 1, wherein the user action and subsequent user action further comprising: controlling the on-demand video program transmission with a remote control or manual input, having plural buttons including at least a PLAY button and a STOP or PAUSE button.

3. The method of claim 1, wherein the broadcast video signal is comprised of video on-demand data and video on-demand commands; said video on-demand commands contains a date and time upon which the video on-demand will be unavailable.

4. The method of claim 1, wherein the broadcast video signal is comprised of video on-demand data and video on-demand commands; said video on-demand commands contains an indicator that will or will not allow the user to perform copy commands of this video on-demand.

5. A method of providing on-demand video comprising: on-demand video data stored in a local storage device; sending to the TV via the video output a signal displaying the current status of the local storage and a list of user commands; receiving a user action command by actuating a button located on the remote control or on the local video player, or highlighting the command on the TV and depressing the ENTER button on the remote control; executing said command by performing the actions required for said command.

6. The method of claim 5, wherein the execution of a DUPLICATE VIDEO command comprises: transferring a selected video form either local storage, or external storage or another network location to a video data recorded and recording the video data on a selected media.

7. The method of claim 5, wherein the execution of a SAVE VIDEO command comprises: transferring a selected video from local storage to external storage or another network location.

8. The method of claim 5, wherein the execution of a LOAD VIDEO command comprises: transferring a selected video to local storage from external storage or another network location.

9. The method of claim 5, wherein the execution of a LOAD APPLICATION command comprises: transferring data that is an application from external storage or another network location to the video on-demand processing unit.

10. The method of claim 9, wherein the execution of said command comprises: upon the completed transfer of said application to said processing unit, said processing unit starts executing said application.

11. The method of claim 5, wherein the execution of a RUN APPLICATION command comprises: start executing in the video on-demand processing unit a currently loaded and selected application.

12. A device to provide video on-demand comprising: a plurality of video input ports; a processing unit where said video input ports are connected; a video player connected to the processing unit; a local storage connected to the processing unit and said video player; a plurality of video output ports; said video output ports connected to the processing unit; at least one of said video output ports connected to the video player; a plurality of digital input and output ports connected to the processing unit.

13. The video on-demand device of claim 12, wherein: said video player is also a video recorder.

14. The video on-demand device of claim 12, wherein: one of the said digital input and output ports is an interface to an external storage unit.

15. The video on-demand device of claim 12, wherein: one of the said digital input and output ports is a network interface unit.

16. The video on-demand device of claim 12, wherein: said video player is optionally also a video recorder; where one of the said digital input and output ports is optionally an
